(19) United States
(12) Patent Application Publication
(10) Pub. No.: US 2025/0079563 A1
(43) Pub. Date: Mar. 6, 2025

(54) BATTERY MODULE

(71) Applicant: MAHLE International GmbH, Stuttgart (DE)

(72) Inventors: Dieter Reisinger, Muehlacker (DE); Dragos-Cristian Iancu, Hitzhofen (DE); Thomas Kalmbach, Ostfildern (DE); Eduard Reimer, Fellbach (DE)

(21) Appl. No.: 18/820,240

(22) Filed: Aug. 29, 2024

(30) Foreign Application Priority Data
Sep. 1, 2023 (DE) 102023208445.7

(51) Int. Cl. H01M 10/6556; H01M 10/613; H01M 10/6567; H01M 50/213

(52) U.S. Cl. CPC H01M 10/6556; H01M 10/613; H01M 10/6567; H01M 50/213

(57) ABSTRACT

A battery module for a battery including a plurality of battery modules may include a cell volume, a plurality of battery cells accommodated in the cell volume, a plate-shaped fluid manifold, an intermediate plate, and a manifold volume limited by the fluid manifold and the intermediate plate. The fluid manifold may include at least one fluid inlet port on a side facing the intermediate plate. The inlet port may include at least one inlet opening that is fluidically connected to the manifold volume such that a flow path of a cooling medium extends through the inlet port and through the inlet opening into the manifold volume. The fluid manifold may include throttle openings that fluidically connect the manifold volume to the cell volume such that the flow path from the manifold volume extends through the throttle openings into the cell volume.

### CROSS-REFERENCE TO RELATED APPLICATIONS

This application claims priority to German Patent Application no. DE 102023208445.7, filed on Sep. 1, 2023, the contents of which is hereby incorporated by reference in its entirety.

### TECHNICAL FIELD

The present invention relates to a battery module for a battery comprising battery cells. The invention further relates to a battery, in particular a traction battery, having such battery modules, which are arranged one after the other in the battery.

### BACKGROUND

A battery comprises battery cells for the provision and storage of electrical energy. The number and arrangement of the battery cells is usually adapted to the respective requirements and circumstances. In order to simplify the production of such a battery and/or to flexibly fulfill the requirement and/or the circumstances, such a battery can comprise battery modules with battery cells that are electrically connected to one another within the battery.

Such batteries are used in particular for increased power requirements, for example as a traction battery. In particular for increased power requirements, the battery cells usually require temperature control, i.e. cooling and/or heating. The temperature control can be implemented with a cooling medium that flows through the battery and thus controls the temperature of the battery cells.

### SUMMARY

The present invention deals with the task of providing improved or at least alternative embodiments for a battery module of a battery of the aforementioned type and for such a battery.

The invention solves this problem by the scope of the independent claim(s). Advantageous embodiments are the scope of the dependent claim(s).

The present invention is therefore based on the basic idea to arrange adjacent to the battery cells of the battery module a plate-shaped fluid manifold in a battery module for a battery in which such battery modules follow each other in one direction, wherein said plate-shaped fluid manifold is fluidically connected by throttle openings to a volume accommodating the battery cells such that a cooling medium reaches the volume and the battery cells via the throttle openings, in order to control the temperature of the battery cells. The coolant is thus introduced specifically into the volume, thus achieving a homogeneous flow of the coolant through the volume and thus along the battery cells. This results in homogeneous temperature control of the battery cells within the module as well as in the entire battery, while at the same time simplifying implementation and manufacturing.

According to the inventive idea, the battery module has a volume, hereinafter also called cell volume, in which battery cells are accommodated. In an associated battery, at least two such battery modules are advantageously arranged one after the other in the aforementioned direction, which is hereinafter also referred to as the first direction. The battery cells of the battery module are arranged one after the other in a second direction running transversely to the first direction and in a third direction running transversely to the first direction and transversely to the second direction. The cell volume is open on a first side in the first direction, wherein the fluid manifold is arranged on the first side. The fluid manifold is plate-shaped. An intermediate plate that limits a volume with the fluid manifold, which is hereinafter also referred to as the manifold volume, is arranged on the side of the fluid manifold facing away from the cell volume. On the side facing the intermediate plate, the fluid manifold has at least one fluid port having an opening fluidically connected to the manifold volume, which is hereinafter also referred to as an inlet opening. The fluid port is hereinafter also referred to as the fluid inlet port. The fluid manifold therefore comprises at least one fluid inlet port on the side facing the intermediate plate. The respective fluid inlet port comprises at least one inlet opening fluidically connected to the manifold volume such that a flow path of a cooling medium leads through the respective fluid inlet port and through the at least one inlet opening into the manifold volume. During operation, the cooling medium therefore flows through the respective fluid inlet port through the respectively associated at least one inlet opening into the manifold volume. The fluid manifold also has openings open to the cell volume in the first direction, which are spaced apart from one another and fluidically connect the manifold volume to the cell volume. These openings are hereinafter also referred to as throttle openings. Subsequently, the flow path from the manifold volume leads through the throttle openings into the cell volume. During operation, the cooling medium therefore flows from the manifold volume via the throttle openings into the cell volume and thus to the battery cells.

The arrangement of the throttle openings is such that a homogeneous inflow of the cooling medium into the cell volume occurs. The throttle openings are therefore arranged such that the cooling medium homogeneously flows around the battery cells.

The cooling medium is used for temperature control during operation, i.e. for cooling and/or heating the battery cells. For this purpose, the battery cells can be submersed in the cooling medium. The temperature control is therefore carried out in the manner of so-called immersion cooling or submersion cooling. The cooling medium is advantageously a dielectric liquid.

The battery cells can be of any kind.

The battery cells are in particular electrochemical battery cells.

The battery cells can in particular be adapted as round cells that extend lengthwise along the first direction.

The battery module advantageously comprises a housing limiting the cell volume, which is hereinafter also referred to as module housing.

The module housing is preferably closed on the first side of the fluid manifold. The fluid manifold thus forms a housing cover of the module housing. The fluid manifold thus combines the fluid distribution function and the housing cover. This results in a considerably simplified and cost-effective production of the battery, whereby the installation space requirement is simultaneously reduced.

The module housing preferably has a bottom on the side of the cell volume facing away from the fluid manifold, which is hereinafter also referred to as the housing bottom. The housing bottom preferably limits the cell volume on a second side opposite the fluid manifold in the first direction of the first side. The fluid manifold and the housing bottom are therefore advantageously arranged opposite in the first direction, wherein the battery cells are arranged between the fluid manifold and the housing bottom.

In preferred embodiments, the housing bottom has openings to allow coolant to exit from the cell volume, which are hereinafter also referred to as collector openings.

In preferred embodiments, the housing bottom together with the intermediate plate of the adjacent battery module limits a volume in the battery, which is hereinafter also referred to as collection volume. The collector openings thus connect the cell volume to the collection volume such that the flow path leads from the cell volume through the collector openings into the collection volume. This means that during operation, the cooling medium flows from the cell volume via the collector openings into the collection volume.

The housing bottom comprises at least one fluid port for collecting the coolant flowing into the collection volume and removing it from the battery module, which is hereinafter also referred to as a fluid outlet port. The respectively at least one fluid outlet port comprises at least one opening fluidically connected to the collection volume which is hereinafter also referred to as an outlet opening. The flow path of the cooling medium thus leads from the collection volume through the respective outlet opening into the at least one fluid outlet port.

As explained above, at least two such battery modules are arranged one after the other in the first direction. The battery thus has two externally arranged battery modules in the first direction, which are subsequently also referred to as the first external battery module and the second external battery module.

On the side facing away from the intermediate plate of the first external battery module in the first direction, a first end plate is preferably arranged that has a fluid inlet for the respective fluid inlet port of the outermost battery module for feeding coolant into the battery. The respectively at least one fluid inlet is fluidically connected to the associated fluid inlet port of the first external battery module. The respectively at least one fluid inlet is advantageously seated into the associated fluid inlet port of the first external battery module.

The battery preferably has a second end plate on the side facing away in the first direction from the cell volume of the second external battery module. The second end plate is therefore arranged on the side of the housing bottom of the second external battery module facing away in the first direction from the fluid manifold of the second external battery module. The second end plate with the housing bottom of the second external battery module can limit the collection volume for the second external battery module. This means that the collection volume for the second external battery module—in contrast to the remaining battery modules—cannot be limited by the housing bottom and the intermediate plate of the adjacent battery module, but is instead limited by the housing bottom and the second end plate. Alternatively, such an intermediate plate can be arranged between the second end plate and the housing bottom of the second external battery module, which limits the collection volume of the second external battery module together with the housing bottom. In contrast to the other battery modules, the collection volume is not limited in this case by the housing bottom and the intermediate plate of the adjacent battery module, but by the separately provided intermediate plate.

The second end plate preferably comprises at least one fluid outlet for discharging coolant from the battery. The fluid outlet is fluidically connected to the at least one fluid outlet port of the second external battery module. The at least one fluid outlet is preferably seated into the at least one fluid outlet port of the second external battery module.

The respective intermediate plate is preferably thermally insulating, in particular as a thermal barrier. For this purpose, the intermediate plate is expediently made of a material with low thermal conductivity and consists in particular of such a material. Preferably, the intermediate plate is made of Mica, also referred to as “glimmer”, and in particular consists of Mica. This results in a reduced heat transfer between the manifold volume and the collection volume. This results in an increased efficiency of the temperature control function.

In the battery, the fluid inlet ports of the battery modules are preferably fluidically connected to one another and the fluid outlet ports of the battery modules are fluidically connected to one another. This means that the cooling medium in the battery also flows via the fluid inlet ports to the adjacent battery modules. This also means that the cooling medium in the battery leads to the adjacent battery modules via the fluid outlet ports. The fluid inlet ports are expediently separated from the fluid outlet ports or connected only via the throttle openings and outlet openings. The fluid inlet ports of the battery modules are therefore preferably fluidically connected to, in particular inserted into, each other but are fluidically separated from the cell volume. In addition, the fluid outlet ports of the battery modules are fluidically connected to, in particular inserted into, each other but are fluidically separated from the cell volume.

The battery can be used in any application. The battery can in particular be used in a motor vehicle.

The battery is in particular a traction battery. In the motor vehicle, the battery is thus used to drive the motor vehicle, for example by means of at least one electric motor.

In the motor vehicle, the first direction preferably extends transversely to a Z-direction of the motor vehicle. In particular, the first direction extends along a Y direction and thus transverse to the direction of travel of the motor vehicle.

Preferred embodiments are those wherein the fluid manifold has ribs projecting in the first direction on the side facing the intermediate plate and spaced apart in the second direction, which are hereinafter also referred to as manifold ribs. The intermediate plate is located on the manifold ribs to form the manifold volume.

The respective manifold rib is preferably interrupted along the third direction, i.e. has at least one interruption along the third direction, which is hereinafter also referred to as a manifold interruption. The flow path accordingly leads within the manifold volume through the at least one manifold interruption. This results in a more homogeneous flow of the cooling medium through the manifold volume and via the throttle openings to the battery cells. This means that a more homogeneous temperature control of the battery cells is achieved in this way.

On the side facing away from the cell volume, the housing bottom preferably comprises ribs projecting in the first direction and spaced apart from one another in the second direction, which are hereinafter also referred to as collector ribs. The intermediate plate of the next battery module is located in the battery to form the collection volume on the collector ribs. In the second external battery module, the separately provided intermediate plate can lie on the collector ribs to form the collection volume.

The respective collector rib is advantageously interrupted in the third direction, i.e. has at least one interruption in the third direction, which is hereinafter also referred to as collector interruption. The flow path consequently leads through the collector interruptions within the collection volume. This results in a more homogeneous flow of the cooling medium through the collection volume and thus in an overall more homogeneous flow through the respective battery module and through the battery. This results in a more homogeneous temperature control of the battery cells and the respective battery module as well as the battery.

At least one of the collector ribs can have a main section projecting along, or at an incline to, the third direction, from which at least two arms project, wherein such a collector opening is arranged between at least two of the arms. The arms and the main section together form a guided flow of the coolant through the collection volume, which leads to a more homogeneous flow of the collection volume and thus to a more homogeneous flow of the coolant from the cell volume. This results in a more homogeneous temperature control of the battery cells.

In preferred embodiments, the battery cells in the respective battery module are braced against the associated housing bottom or are located on the housing bottom. This is preferably done in such a way that the flow path is limited by at least a portion of the battery cells facing the housing bottom. This means that the cooling medium flows along, and is in contact with, said undersides during operation. This leads to improved temperature control of the battery cells.

The arrangement of the throttle openings is preferably adapted to the sequence of the battery cells in the cell volume. This results in a more homogeneous flow of the cooling medium into the cell volume and along the battery cells and thus in a more homogeneous temperature control.

The arrangement of the collector openings is preferably adapted to the sequence of the battery cells in the cell volume. This leads to a more homogeneous flow of the cooling medium along the battery cells on the cell volume and thus to a more homogeneous temperature control.

It is preferred if the arrangement of the interruptions, i.e. the arrangement of the manifold interruptions and/or the arrangement of the collector interruptions are adapted to the sequence of the battery cells in the cell volume. This results in a more homogeneous flow of the cooling medium and consequently in a more homogeneous temperature control.

In advantageous embodiments, the battery cells are arranged in rows of cells extending along the second direction that are spaced apart from one another in the third direction. In addition, the throttle openings are arranged in rows of throttles extending along the second direction that are spaced part from one another in the third direction. Alternatively or additionally, the collector openings are arranged in collection rows extending along the second direction and are spaced part from one another in the third direction.

The interruptions, in particular the manifold interruptions, are preferably arranged in interruption rows running along the second direction that are spaced apart from one another in the third direction.

The rows of cells that follow in the third direction can be offset in relation to one another in the second direction. Advantageously, the rows of throttles successively arranged in the third direction are likewise offset in relation to one another in the second direction. Alternatively or additionally, collection rows successively arranged in the third direction are advantageously offset in relation to one another in the second direction.

The interruption rows successively arranged in the third direction are preferably offset in relation to one another in the second direction.

The throttle openings and the collector openings can be mounted in any way in the fluid manifold or in the housing bottom.

In preferred embodiments, the throttle openings are adapted as a hole pattern in the fluid manifold.

The collector openings are preferably adapted as a hole pattern in the housing bottom.

The fluid manifold can comprise at least one bursting element adapted in the fluid manifold as a depression directed away from the cell volume. This results in a controlled pressure reduction in the cell volume, for example in the event of overheating in the cell volume.

In advantageous embodiments, one such manifold rib of the fluid manifold leads through at least one of the at least one bursting elements. Such a manifold rib can thus lead through the respective bursting element.

The fluid manifold can in principle comprise a single fluid inlet port.

The fluid manifold preferably comprises two fluid inlet ports spaced apart from one another in the second direction and preferably arranged on the perimeter side. Thus, a more uniform flow of the cooling medium into the manifold volume is achieved. In this way, there is an overall more homogeneous flow of the cooling medium through the manifold volume and consequently into the cell volume. This means that a more homogeneous temperature control is achieved in this way.

The housing bottom can in principle comprise two or more fluid outlet ports.

The housing bottom preferably comprises a single fluid outlet port advantageously arranged centrally in the second direction. This results in a simplified design of the battery module and thus of the battery.

The fluid outlet port is preferably arranged between the fluid inlet ports in the second direction and spaced at a distance in relation to the fluid inlet ports in the third direction.

It goes without saying that such a battery, in particular such a traction battery, as such is also part of the scope of this invention.

Further important features and advantages of the invention are apparent from the sub-claims, from the drawings and from the associated description of the figures with reference to the drawings.

It is understood that the above-mentioned features and those yet to be explained below can be used not only in the combination indicated in each case, but also in other combinations or on their own, without deviating from the scope of the present invention.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWINGS

These show, schematically in each case, in:

FIG. 1 shows an isometric view of a battery with successively arranged battery modules and a dismantled battery module in an exploded view,

FIG. 2 shows an enlarged view of FIG. 1 in the region of battery cells of the dismantled battery module,

FIG. 3 shows a sectional view of the battery,

FIG. 3a shows an enlarged view of a section of FIG. 3,

FIG. 4 shows an isometric view of a fluid manifold of a battery module,

FIG. 5 shows a different isometric view of the fluid manifold,

FIG. 6 shows an isometric view of a housing bottom of the battery module,

FIG. 7 shows a different isometric view of the housing bottom,

FIG. 8 shows an isometric, exploded view of the battery module toward such a fluid manifold,

FIG. 9 shows an isometric, exploded view of the battery module toward such a housing bottom.

### DETAILED DESCRIPTION

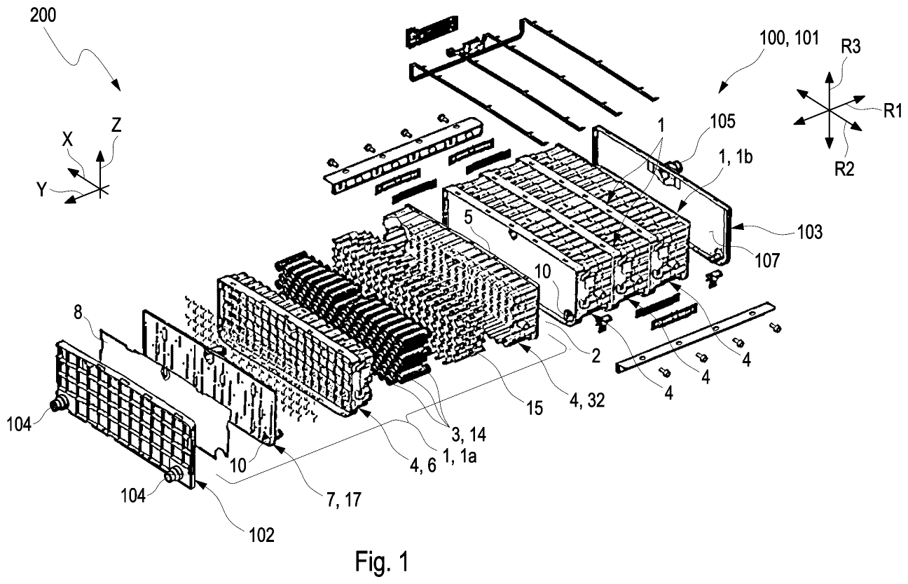

A battery module 1, as shown by way of example in FIGS. 1 through 3, 3a and 8 and 9, is used in a battery 100 shown by way of example in FIGS. 1 through 3. The battery 100 is in particular a traction battery 101 for a battery-electric motor vehicle 200 indicated in FIG. 1 and otherwise not shown. The battery 100 comprises at least two, advantageously a plurality of, such battery modules 1. In the exemplary embodiment shown in FIGS. 1 through 3, the battery 100 has four such battery modules 1 strictly as an example. The battery modules 1 are arranged in succession along a direction R1, which is hereinafter also referred to as the first direction. In the exemplary embodiments shown, the battery modules 1 are stacked in the first direction R1, in particular plugged together, and thus mounted together. Along the first direction R1, the battery 100 comprises two external battery modules 1, namely a first external battery module 1, 1a and a second external battery module 1, 1b opposite to the first external battery module 1, 1a. In the illustration of FIG. 1, the three battery modules 1 shown on the right are shown in the assembled state and mounted together or stacked together, whereas the fourth battery module 1 shown on the left, which corresponds to the first external battery module 1, 1a in the illustration, is pulled apart and thus shown in an exploded illustration.

When using the battery 100, in particular the traction battery 101, in the motor vehicle 200, the first direction R1 extends advantageously transversely to a Z-direction Z of the motor vehicle 200 and in particular along a Y-direction Y of the motor vehicle 200 and thus transversely X-direction X and consequently transversely to the direction of travel.

In the exemplary embodiments shown, the individual battery modules 1 are adapted as cuboids, strictly by way of example. FIG. 1 shows further peripheral components of the battery 100, which, however, are not described in more detail and can, for example, be used for electrical contacting and to fasten the battery modules 1 to one another.

One of the battery modules 1 is discussed below. Since the battery modules 1 have identical adaptations, the description can be transferred analogously to the remaining battery modules 1.

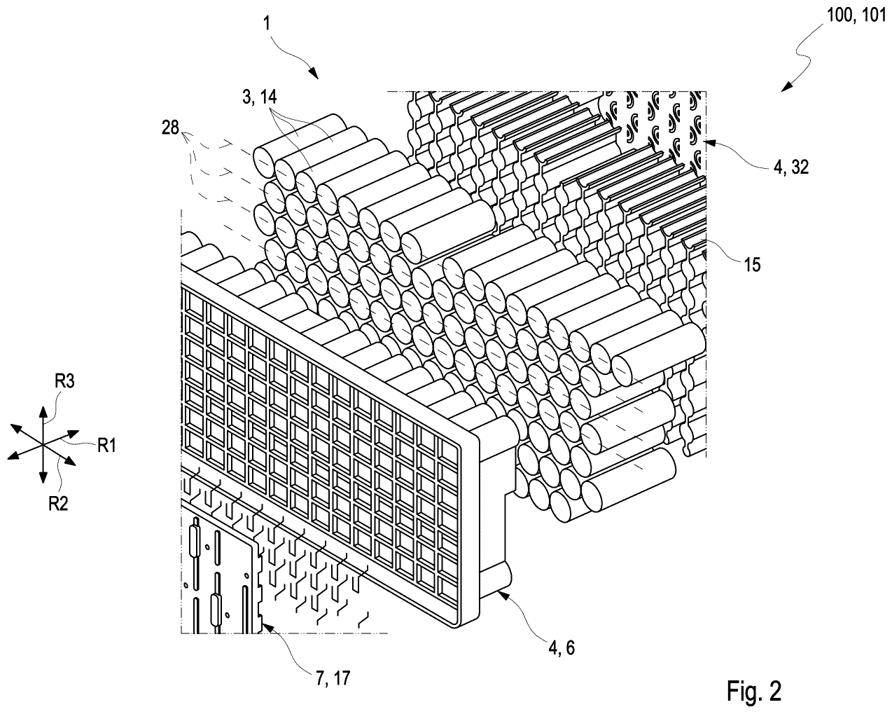

The battery module 1 has a volume 2 in which electrochemical battery cells 3 are accommodated. Volume 2 is also referred to below as cell volume 2. As can be seen in FIG. 1, the respective battery module 1 can have a mounting structure 15 that holds and/or secures the battery cells 3 in the cell volume 2. In the exemplary embodiments shown, the battery module 1 comprises a housing 4, which is hereinafter also referred to as a module housing 4 and limits the cell volume 2 and thus accommodates the battery cells 3. In the exemplary embodiments shown, as can be seen in particular in FIG. 2, the battery cells 3 are adapted as so-called round cells 14, which have a cylindrical shape. In the exemplary embodiments shown, the round cells 14 extend lengthwise along the first direction R1. In the cell volume 2, the battery cells 3 are arranged in succession or next to one another in a second direction R2 running transverse to the first direction R1 and in a third direction R3 running transversely to the first direction R1 and transversely to the second direction R2.

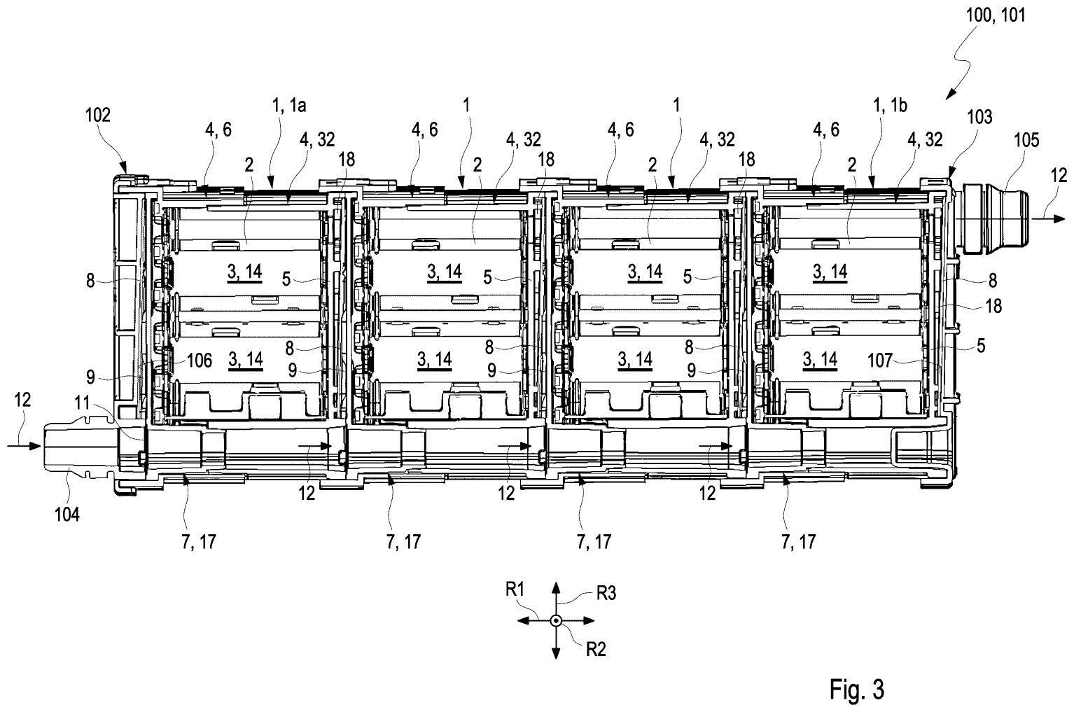

In the exemplary embodiments shown, the module housing 4 comprises a housing lower part 32 with a housing bottom 5 and a housing upper part 6 following the housing lower part 5 in the first direction R1, which limit the cell volume 2. The battery cells 3 of the battery module 1 can be braced on the housing bottom 5. The cell volume 2 is open along the first direction R1 on one side, which is hereinafter also referred to as the first side. This also means that the module housing 4 is open on the first side, i.e. in the exemplary embodiments shown opposite the housing bottom 5 along the first direction R1. On the first side and thus opposite the housing bottom 5 in the first direction R1, the battery module 1 comprises a fluid manifold 7, which is plate-shaped. In the exemplary embodiments shown, the fluid manifold 7 closes the module housing 4 on the first side and is thus simultaneously adapted as a housing cover 17 that closes the module housing 4. On the side of the fluid manifold 7 facing away from the cell volume 4 and thus from the battery cells 2, the battery module 1 comprises a plate 8, which is hereinafter also referred to as intermediate plate 8. As can be seen in FIG. 3, the fluid manifold 7 and the intermediate plate 8 limit a volume 9, which is hereinafter also referred to as the manifold volume 9.

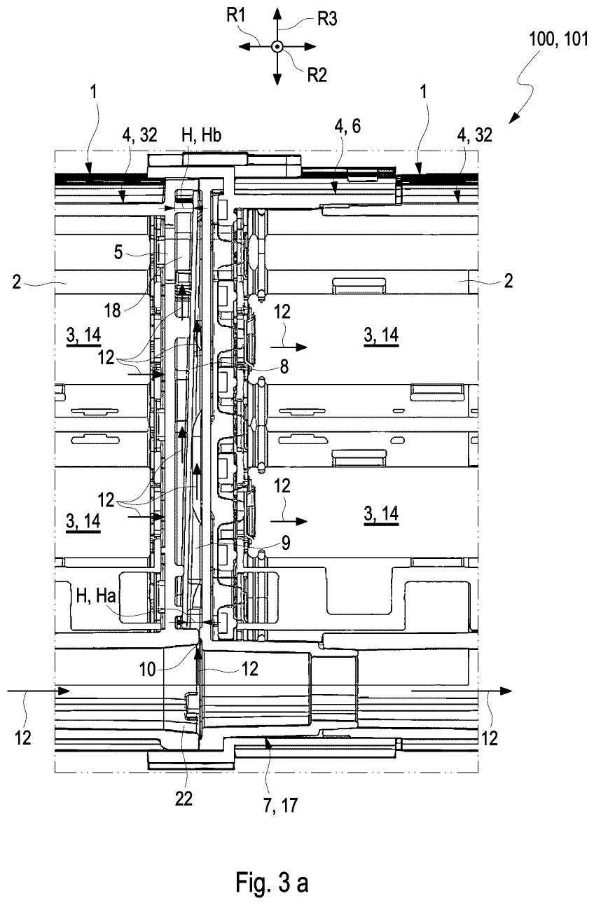

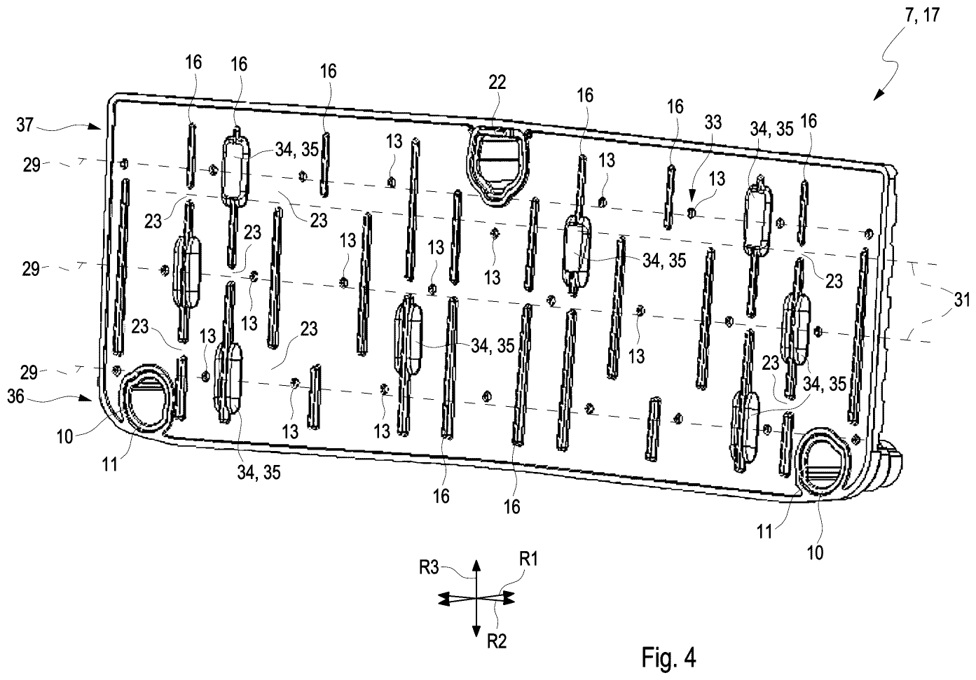

FIGS. 4 and 5 show isometric views of the fluid manifold 7, wherein FIG. 4 shows an isometric view of the fluid manifold 7 toward the side facing the intermediate plate 8, and FIG. 5 shows an isometric view of the fluid manifold 7 toward the side facing the cell volume 2. As can be seen in particular from FIGS. 4 and 5, the fluid manifold 7 has on the side facing the intermediate plate 8 at least one fluid port 10, which is hereinafter also referred to as a fluid inlet port 10. In the exemplary embodiments shown, the fluid manifold 7 comprises two such fluid inlet ports 10, which are spaced apart from one another along the second direction R2 and are arranged in the second direction R2 and in the third direction R3 on the perimeter side of the manifold volume 9. The fluid inlet ports 10 are therefore arranged along the third direction R3 in a perimeter 36 of the manifold volume 9 projecting along the second direction R2, which is hereinafter also referred to as the first perimeter 36. The respective fluid inlet port 10 comprises at least one opening 11, via which a cooling medium can flow into the manifold volume 9 via the fluid inlet port 10, and which is hereinafter also referred to as an inlet opening 11. The respective fluid inlet port 10 thus comprises at least one inlet opening 11 fluidically connected to the manifold volume 9 such that a flow path 12 of the cooling medium leads through the respective fluid inlet port 10 and through the at least one inlet opening 11 into the manifold volume 9. The respective inlet opening 11 thus preferably terminates into the manifold volume 9. In the first direction R1, the fluid manifold 7 comprises openings 13 open toward the cell volume 2 and spaced apart from one another, which are hereinafter also referred to as throttle openings 13. During operation, the cooling medium flows from the manifold volume 9 into the cell volume 2 and thus to the battery cells 3 via the throttle openings 13. The throttle openings 13 thus fluidically connect the manifold volume 9 to the cell volume 2 such that the flow path 12 from the manifold volume 9 leads through the throttle openings 13 into the cell volume 2. This results in a homogeneous flow of the cooling medium into the cell volume 2 and thus in a more homogeneous temperature control, in particular a more homogeneous cooling, of the battery cells 3.

In the exemplary embodiments shown, the battery modules 1 and thus the battery 100 are temperature-controlled by immersion. This means that the battery cells 3 are submersed in the cooling medium during operation. The cooling medium is advantageously a dielectric liquid.

In the exemplary embodiments shown, as can be seen in FIGS. 1 and 3, the battery modules 1 are arranged along the first direction R1 between two end plates 102, 103, namely between a first end plate 102 and a second end plate 103. The first end plate 102 is arranged on the side of the intermediate plate 8 of the first external battery module 1, 1a facing away from the cell volume 2 or the fluid manifold 7. The second end plate 103 is arranged on the side of the housing bottom 5 of the second external battery module 1, 1b facing away from the cell volume 2.

As can be seen in particular in FIG. 3, in the exemplary embodiments shown, the respective housing bottom 5 together with the intermediate plate 8 of the adjacent battery module 1 limits a volume 18, which is hereinafter also referred to as collection volume 18. This applies in the exemplary embodiments shown for all housing bottoms 5 with the exception of the housing bottom 5 of the second external battery module 1, 1b. Together with such an intermediate plate 8 arranged additionally between the housing bottom 5 and the second end plate 103, this housing bottom 5 forms the associated collection volume 18.

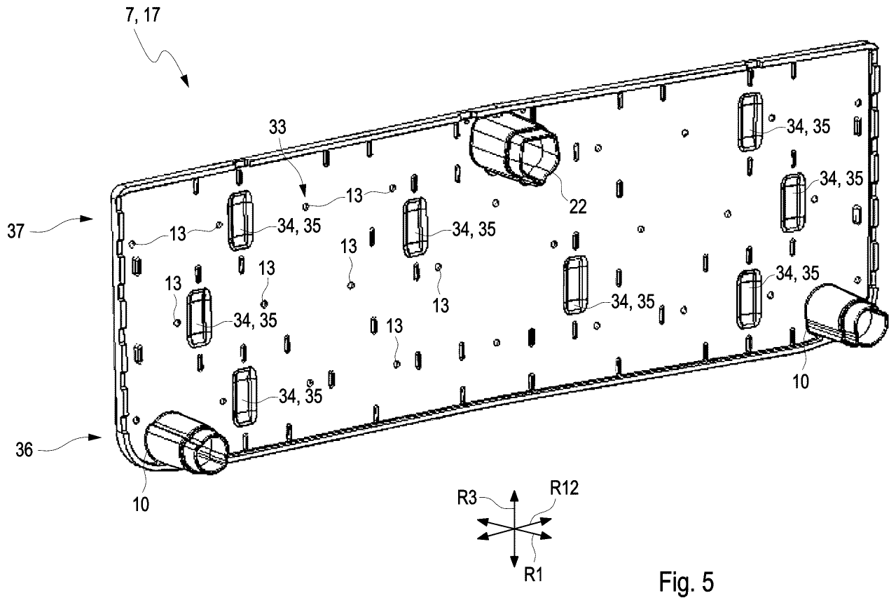

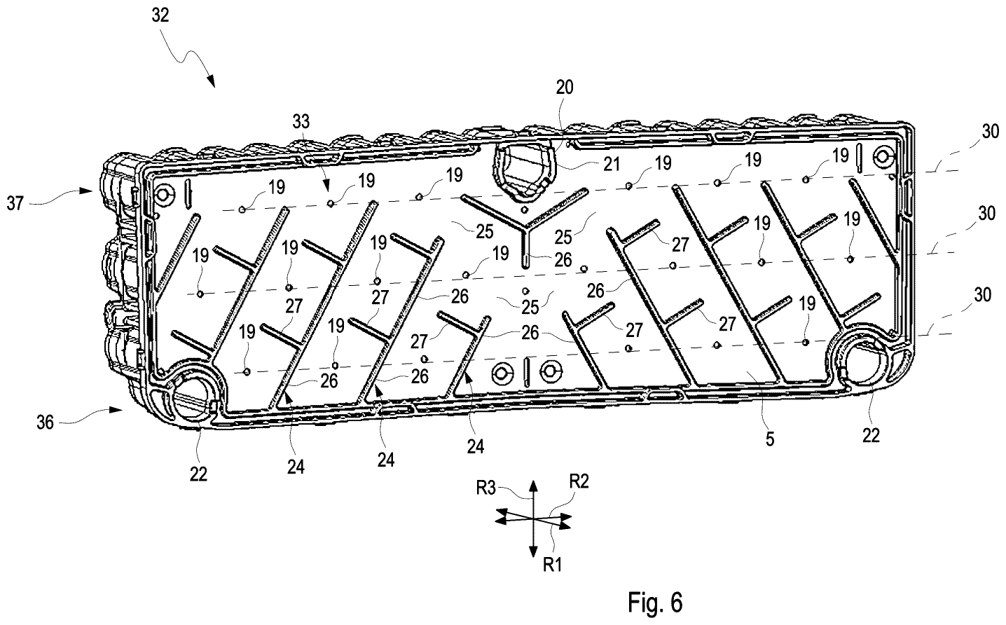

FIGS. 6 and 7 show isometric views of the housing bottom 5, wherein FIG. 6 shows a view towards the side of the housing bottom 5 facing away from the cell volume 2, and FIG. 7 shows a view towards the side of the housing bottom facing toward the cell volume 2. As can be seen in particular from FIGS. 6 and 7, the housing bottom 5 has openings 19 spaced apart from one another in the exemplary embodiments shown, which fluidically connect the cell volume 2 to the collection volume 18. These openings 19 are hereinafter also referred to as collector openings 19. Subsequently, during operation, the coolant flows from the cell volume 2 into the collection volume 18 via the collector openings 19. This means that the flow path 12 leads from the cell volume 2 through the collector openings 19 into the collection volume 18. This also results in a homogeneous flow of the cooling medium from the cell volume 2 and thus in a more homogeneous temperature control, in particular a more homogeneous cooling, of the battery cells 3. As can be seen in particular from FIGS. 6 and 7 and 9, the housing bottom 5 in the shown exemplary embodiments has at least one fluid port 20 for collecting the coolant from the collection volume 18, which is hereinafter also referred to as a fluid outlet port 20. The respective fluid outlet port 20 comprises at least one opening 21 connected to the collection volume 18, which is hereinafter also referred to as the outlet opening 21. Thus, during operation, the coolant flows from the collection volume 18 via the respective at least one outlet opening 21 into the at least one fluid outlet port 20 and thus from the battery module 1. In the exemplary embodiments shown, the housing bottom 5 comprises a single such fluid outlet port 20. In the exemplary embodiments shown, the fluid outlet port 20 is spaced apart from the fluid inlet ports 10 in the third direction R3 and is arranged on the perimeter. In the exemplary embodiments shown, the at least fluid outlet port 20 is therefore arranged along the third direction R3 in a second perimeter 37 of the collection volume 18 extending along the second direction R2, said second perimeter being arranged opposite the first perimeter 36 in the third direction R3. In the exemplary embodiments shown, the fluid outlet port 20 is arranged centrally in the second direction R2.

In the exemplary embodiments shown, the throttle openings 13 are adapted as a hole pattern 33 in the fluid manifold 7. In the exemplary embodiments shown, the collector openings 19 are likewise adapted as a hole pattern 33 in the housing bottom 5.

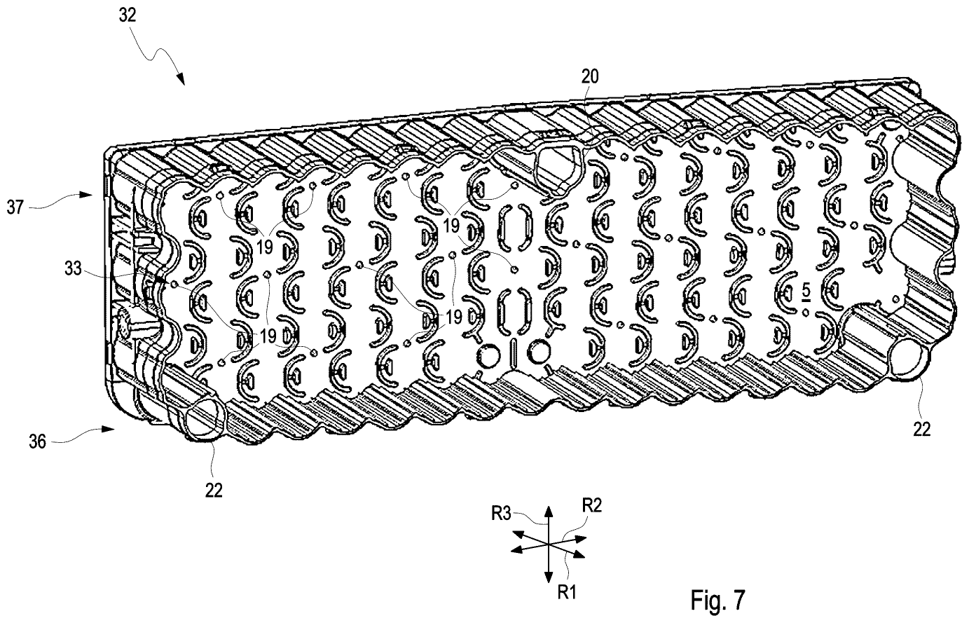

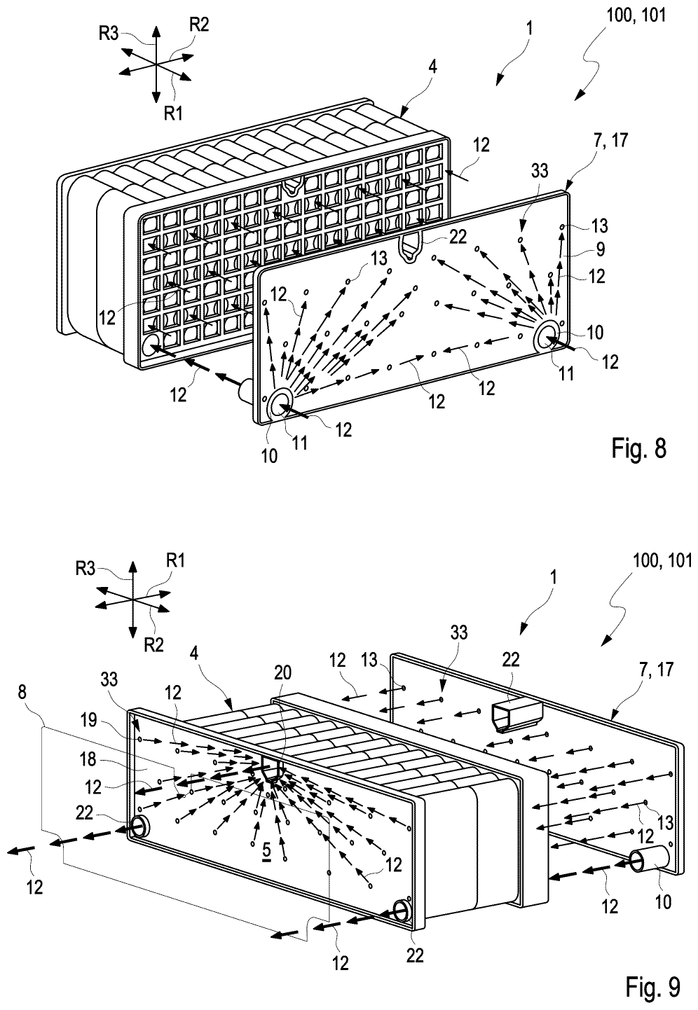

As can in particular be seen in FIG. 3, in the exemplary embodiments shown, the fluid inlet ports 10 of the battery modules 1 are fluidically connected to one another within the battery 100. For this purpose, the fluid inlet ports 10 in the shown exemplary embodiments also extend to the side facing the cell volume 2. The fluid inlet ports 10 are within the cell volumes 2 fluidically separated from the latter. This means that the cooling medium, as indicated by the flow paths 12 shown in FIGS. 8 and 9, flows from the first external battery module 1, 1a to the second external battery module 1, 1b by means of the fluid inlet ports 10 and only flows into the cell volume 2 by means of the associated fluid manifold 7 and throttle openings 13. Likewise, in the exemplary embodiments shown, the fluid outlet port 20 of the battery modules 1 is fluidically connected to one another within the battery 100, but is within the cell volume 2 fluidically separated from the latter. For this purpose, in the exemplary embodiments shown, the respective fluid outlet port 20 also extends to the side facing the cell volume 2. As indicated by the flow paths 12 in FIGS. 8 and 9, this means that the cooling medium flows from the first external battery module 1, 1a to the second external battery module 1, 1b via the fluid outlet ports 20 and only by means of the collector openings 19 from the cell volume 2 into the respectively associated collection volume 18 and from the collection volume 18 via the at least one associated outlet opening 21 into the at least one associated fluid outlet 20. In the illustrations of FIGS. 8 and 9, the flows between the fluid inlet ports 10 and the flows between the fluid outlet ports 20 are for better differentiation indicated with large/thick arrows for the flow path 12 and the flows through the manifold volume 9, through the cell volume 2, and through the collection volumes 18 are indicated with smaller/thinner arrows for the flow path 12.

In the exemplary embodiments shown, the fluidic connections of the fluid inlet ports 10 and the fluidic connections of the fluid outlet ports 20 are implemented by means of plug connections. This means that the fluid inlet ports 10 are inserted into one another. The fluid outlet port 20 are likewise inserted into one another. For the fluidic connection of the fluid outlet ports 20 of the adjacent battery modules 1 with one another, the fluid manifold 7 in the shown exemplary embodiments for the respective fluid outlet port 20 of the housing bottom 5 comprises an associated pass-through port 22, in the exemplary embodiments shown therefore a single pass-through port 22 that is fluidically separated from the manifold volume 9 and cell volume 2 and is fluidically connected to the fluid outlet port 20 of the adjacent battery module 1, and is inserted in the exemplary embodiments shown. In order to fluidically connect the fluid inlet ports 10 of the adjacent battery modules 1 to each other, the housing bottom 5 likewise comprises an associated pass-through port 22, i.e. two pass-through ports 22 in the exemplary embodiments shown, for the respective fluid inlet port 10. The respective pass-through port 22 of the housing bottom 5 is fluidically separated from the collection volume 18 and cell volume 2 and is fluidically connected—inserted into in the shown exemplary embodiments—the associated fluid inlet port 10 of the adjacent battery module 1. In the exemplary embodiments shown, the intermediate plate 8 is recessed in the region of the respective connection 10, 20, 22 (see, for example, FIG. 1).

For example, as can be seen from FIGS. 1 and 3, the first end plate 102 in the exemplary embodiments shown comprises at least one fluid inlet 104 for introducing the coolant into the battery 1. In the exemplary embodiments shown, the first end plate 102 therefore has at least one such fluid inlet 104 for introducing the cooling medium into the manifold volume 9 of the first external battery module 1, 1a. The respective fluid inlet 104 can be arranged on the discharge side of a not shown circulating device, for example a pump, for circulating the coolant. In the exemplary embodiments shown, the first end plate 102 has an associated fluid inlet 104, i.e. two fluid inlets 104, for the respective fluid inlet port 10 of the first external battery module 1, 1a. The respective fluid inlet 104 is fluidically connected—inserted in the shown exemplary embodiment—to an associated fluid inlet ports 10 of the first external battery module 1. Subsequently, during operation, the cooling medium flows via the respective fluid inlet 104 into the associated fluid inlet port 10 of the first external battery module 1, 1a and into the manifold volume 9 of the first external battery module 1, 1a as well as by means of the fluidic connections of the fluid inlet ports 10 described above to the remaining battery modules 1.

As can for example also be seen in FIGS. 1 and 3, the second end plate 103 comprises at least one fluid outlet 105 for discharging the coolant from the battery 1, to which the respective fluid outlet port 20 is fluidically connected. The respective fluid outlet 105 can therefore be arranged on the suction side of the circulating device, in particular the pump. In the exemplary embodiments shown, the second end plate 103 has an associated fluid outlet 105, i.e. a single fluid outlet 105, for the respective fluid outlet port 20 of the second external battery module 1, 1b. The fluid outlet 105 is fluidically connected—inserted in the exemplary embodiments shown—to the fluid outlet port 20 of the second external battery module 1, 1b. The fluid outlet 105 is thus also fluidically connected to the fluid outlet ports 20 of the remaining battery modules 1. During operation, the coolant thus flows into the fluid outlet 105 and out of the battery 100.

As can be seen in FIGS. 3 and 4, the fluid manifold 7 in the exemplary embodiments shown has ribs 16 projecting from the side facing the intermediate plate 8 in the first direction R1 and spaced apart from one another in the second direction R2, on which the intermediate plate 8 lies to form the manifold volume 9. The ribs 16 are also referred to below as manifold ribs 16. In the exemplary embodiments shown, the respective manifold rib 16 has at least one interruption 23 along the third direction R3, which is hereinafter also referred to as a manifold interruption 23. The cooling medium can therefore flow through the manifold volume 9 via the manifold interruptions 23. This means that the flow path 12 in the manifold volume 9 leads through the manifold interruptions 23. This results in a further homogenization of the flow of the cooling medium through the throttle openings 13 and consequently into the cell volume 2 and to the battery cells 3.

As can be seen from FIGS. 3 and 6, the housing bottom 5 in the exemplary embodiments shown has ribs 24 projecting from the side facing away from the cell volume 2 in the first direction R1 and spaced apart from one another in the second direction R2, which are hereinafter also referred to as collector ribs 24. As can be seen in FIG. 3, for example, the intermediate plate 8 of the adjacent battery module 1 or the intermediate plate 8 lies between the second external battery module 1, 1b and the second end plate 103 to form the collection volume 18 on the collector ribs 24. As can be seen in FIG. 6, the respective collector rib 24 has at least one interruption 25 along the third direction R3, which is hereinafter also referred to as a collector interruption 25. The flow path 12 leads through the collector interruptions 25 in the collection volume 18. It can thus flow through the collection volume 18 via the collector interruptions 25. The flow path 12 thus leads through the collector interruptions 25 in the collection volume 18. This results in a further homogenization of the flow of the cooling medium through the collector openings 19 and thus from the cell volume 2. In the exemplary embodiment shown in FIG. 6, the respective collector rib 24 has such a collector interruption 24 strictly as an example.

As can be seen in FIG. 6, at least one of the collector ribs 24 can comprise a main section 26 extending along, or inclined in relation to, the third direction R3, from which at least two arms 27 project. Such a collector opening 19 is arranged between at least two such arms 27. In the exemplary embodiments shown, a plurality of collector ribs 24 have such main sections 26 and arms 27.

As can be seen in FIG. 2, the battery cells 3 in the exemplary embodiments shown are arranged in rows 28 extending along the second direction R2, said rows 28 being spaced apart from one another in the third direction R3. These rows 28 are hereinafter also referred to as cell rows 28. As can further be seen in FIG. 2, the cell rows 28 successively arranged in the third direction R3 are offset in relation to one another in the second direction R2.

In the exemplary embodiments shown, the throttle openings 13 and the collector openings 19 are adapted to the arrangement of the battery cells 3 and in particular to their sequence. As can be seen in the exemplary embodiments shown in FIGS. 4 and 5, the throttle openings 13 are for this purpose arranged in rows 29 extending along the second direction R2 and are spaced apart from one another in the third direction R3, said rows 29 hereinafter also referred to as throttle rows 29. In addition, the throttle rows 29 successively arranged in third direction R3 are offset in relation to one another in the second direction R2.

As can be seen in the exemplary embodiments shown in FIGS. 6 and 7, the collector openings 19 are for this purpose arranged in rows 30 extending along the second direction R2 and are spaced apart from one another in the third direction R3, said rows 30 hereinafter also referred to as collection rows 30. In the exemplary embodiments shown, the collection rows 30 successively arranged in the third direction R3 are offset in relation to one another in the second direction R2.

As can be seen in FIG. 4, the manifold interruptions 23 in the shown exemplary embodiments are arranged in interruption rows 31 extending along the second direction R2, said interruption rows 31 being spaced apart from one another in the third direction R3. The interruption rows 31 successively arranged in the third direction R3 are offset in relation to one another in the second direction R2.

As shown in FIGS. 4 and 5, the fluid manifold 7 can comprise at least one bursting element 34 adapted in the fluid manifold 7 as a depression 35 directed away from the cell volume 2. The respective bursting element 34 is therefore adapted as a projection on the side facing away from the cell volume 2 in the first direction R1. In the exemplary embodiments shown, the fluid manifold 7 comprises a plurality of such bursting elements 34. In the exemplary embodiments shown, a manifold rib 16 of the fluid manifold 7 in this case extends through the respective bursting element 34 of at least one of the at least one bursting elements 34.

As can be seen from FIG. 3, the respective manifold volume 9 in the exemplary embodiments shown decreases from the inlet openings 11 and thus from the fluid inlet ports 10 along the third direction R3. In the exemplary embodiments shown, the respective manifold volume 9 therefore decreases from the first perimeter 36 along the third direction R3 and thus towards the second perimeter 37. The reduction of the manifold volume 9 is substantially continuous. In the exemplary embodiments shown, the respective collector volume 18 also decreases starting from the at least one outlet opening 21 and thus starting from the fluid outlet port 20 along the third direction R3 and inversely in relation to the manifold volume 9. In the exemplary embodiments shown, the respective collection volume 18 thus decreases from the second perimeter 37 along the third direction R3 and thus toward the first perimeter 36. The decrease of the collection volume 18 is in this case substantially continuous.

In the exemplary embodiments shown, the respective intermediate plate 8 for this purpose extends inclined in relation to the third direction R3 such that the respectively associated manifold volume 9 and collection volume 18, inversely decrease as described along the third direction R3.

In the exemplary embodiments shown, this is accomplished by means of the heights H of the ribs 16, 24 extending in the third direction R3 (see FIG. 3a). This means that a manifold rib height H, Ha of the manifold ribs 16 extending in the first direction R1 decreases from at least one of the at least one inlet openings 11 along the third direction R3 such that the intermediate plate 8 extends inclined in reference to the third direction R3 and the manifold volume 9 decreases along the third direction R3. In addition, a collector rib height H, Hb of the collector ribs 24 extending in the first direction R1 decreases from at least one of the at least one outlet openings 21 along the third direction R3 such that the intermediate plate 8 extends inclined in relation to the third direction R3 and the collection volume 18 decreases inversely to the manifold volume 9 along the third direction R3.

In order to also achieve the reduction of the manifold volume 9 of the first external battery module 1, 1a, the first end plate 102 extends inclined in relation to the third direction R3 with an inner surface 106 facing the intermediate plate 8 of the first external battery module 1, 1a. The inner surface 106 is hereinafter also referred to as the first end plate inner surface 106. As described above, the intermediate plate 8 lies on, or is braced against, the first end plate inner surface 106 such that the manifold volume 9 of the first external battery module 1, 1a decreases as described along the third direction R3. In order to implement the decrease in the collection volume 18 of the second external battery module 1, 1b, an inner surface 107 of the second end plate 103 facing the housing bottom 5 of the second external battery module 1, 1b extends inclined in relation to the third direction R3. This inner surface 107 is hereinafter also referred to as the second end plate inner surface 107. The intermediate plate 8 arranged between the housing bottom 5 of the second external battery module 1, 1b and the second end plate 103 lies on, or is braced against, the second end plate inner surface 107 such that the collection volume 9 of the second external battery module 1, 1b decreases as described along the third direction R3.

In the exemplary embodiments shown, the respective intermediate plate 8 is adapted as a thermal barrier, for example manufactured from Mica.

1. A battery module for a battery including a plurality of battery modules arranged to follow one another in the battery in a first direction, the battery module comprising:
a cell volume limited in the battery module;
a plurality of battery cells accommodated in the cell volume;
the plurality of battery cells arranged following one another in a second direction, which extends transversely to the first direction, and in a third direction, which extends transversely to the first direction and transversely to the second direction;
wherein the cell volume is open on a first side in the first direction;
wherein a plate-shaped fluid manifold is arranged on the first side and an intermediate plate is arranged on a side of the fluid manifold facing away from the cell volume, the fluid manifold and the intermediate plate limiting a manifold volume;
wherein the fluid manifold includes at least one fluid inlet port on a side facing the intermediate plate;
wherein the at least one fluid inlet port includes at least one inlet opening that is fluidically connected to the manifold volume such that a flow path of a cooling medium extends through the at least one fluid inlet port and through the at least one inlet opening into the manifold volume; and
wherein the fluid manifold further includes a plurality of throttle openings opening in the first direction toward the cell volume and arranged spaced apart from one another that fluidically connect the manifold volume to the cell volume such that the flow path from the manifold volume extends through the plurality of throttle openings into the cell volume.

2. The battery module according to claim 1, wherein:
the fluid manifold further includes a plurality of manifold ribs projecting in the first direction on the side facing the intermediate plate and arranged spaced apart from one another in the second direction;
the intermediate plate lies on the plurality of manifold ribs to form the manifold volume; and
the plurality of manifold ribs include a plurality of manifold interruptions, each of the plurality of manifold ribs including at least one manifold interruption of the plurality of manifold interruptions along the third direction such that the flow path in the manifold volume extends through the plurality of manifold interruptions.

3. The b module according to claim 1, further comprising a housing bottom delimiting the cell volume, wherein:
the housing bottom is arranged on a second side of the cell volume opposite the first side in the first direction;
the housing bottom includes a plurality of collector openings disposed spaced apart from one another, the plurality of collector openings fluidically connecting the cell volume to a collection volume limited in the battery by the housing bottom and an intermediate plate of an adjacent battery module such that the flow path extends from the cell volume through the plurality of collector openings into the collection volume;
the housing bottom further includes at least one fluid outlet port; and
the at least one fluid outlet port includes at least one outlet opening that is fluidically connected to the collection volume such that the flow path of the cooling medium extends from the collection volume through the at least one outlet opening into the at least one fluid outlet port.

4. The b module according to claim 3, wherein:
the housing bottom includes a plurality of collector ribs projecting in the first direction on a side facing away from the cell volume and arranged spaced apart from one another in the second direction, the intermediate plate of the adjacent battery module disposed on the plurality of collector ribs to form the collection volume; and
the plurality of collector ribs include a plurality of collector interruptions, each of the plurality of collector ribs including has at least one collector interruption of the plurality of collector interruptions along the third direction such that the flow path extends through the plurality of collector interruptions in the collection volume.

5. The battery module according to claim 4, wherein:
at least one collector rib of the plurality of collector ribs includes a main section extending at least one of along and inclined in relation to the third direction;
the at least one collector rib further includes at least two arms projecting from the main section; and
at least one collector opening of the plurality of collector openings is arranged between the at least two arms.

6. The battery module according to claim 1, further comprising a module housing that limits the cell volume, wherein the fluid manifold closes the module housing on the first side.

7. The battery module according to claim 1, wherein:
the plurality of battery cells are arranged in a plurality of rows of cells extending along the second direction that are disposed spaced apart from one another in the third direction; and
the plurality of throttle openings are arranged in a plurality of rows of throttles extending along the second direction that are disposed spaced apart from one another in the third direction.

8. The battery module according to claim 7, wherein:
the plurality of rows of cells successively arranged in the third direction are offset in relation to one another in the second direction; and
the plurality of rows of throttles successively arranged in the third direction are offset in relation to one another in the second direction.

9. The battery module according to claim 2, wherein the plurality of manifold interruptions are arranged in a plurality of interruption rows extending along the second direction and disposed spaced apart from one another in the third direction.

10. The battery module according to claim 9, wherein the plurality of interruption rows successively arranged in the third direction are offset in relation to one another in the second direction.

11. The battery module according to claim 3, wherein the plurality of collector openings are arranged in a plurality of collection rows extending along the second direction and disposed spaced apart from one another in the third direction.

12. The battery module according to claim 11, wherein the plurality of collection rows successively arranged in the third direction are offset in relation to one another in the second direction.

13. The battery module according to claim 1, wherein the plurality of throttle openings are adapted as a hole pattern in the fluid manifold.

14. The battery module according to claim 3, wherein the plurality of collector openings are adapted as a hole pattern in the housing bottom.

15. The battery module according to claim 2, wherein:
the fluid manifold further includes at least one bursting element adapted in the fluid manifold as a recess directed away from the cell volume; and
a manifold rib of the plurality of manifold ribs extends through the at least one bursting elements.

16. The battery module according to claim 1, wherein the at least one fluid inlet port includes two fluid inlet ports disposed spaced apart from one another in the second direction.

17. The battery module according to claim 3, wherein the at least one fluid outlet port includes a single fluid outlet port.

18. The battery module according to claim 17, wherein:
the at least one fluid inlet port includes two fluid inlet ports disposed spaced apart from one another in the second direction; and
the single fluid outlet port is arranged, in the second direction, between the two fluid inlet ports and is disposed spaced apart from the two fluid inlet ports in the third direction.

19. The battery module according to claim 1, wherein the plurality of battery cells are round cells that extend lengthwise in the first direction.

20. The battery module according to claim 1, wherein the intermediate plate is adapted as a thermal barrier.

21. A battery, comprising:
at least two battery modules according to claim 1 successively arranged in the first direction, the at least two battery modules including a first external battery module and a second external battery module disposed opposite the first external battery module in the first direction; and
a first end plate arranged on a side facing away from the intermediate plate of the first external battery module in the first direction, the first end plate including a fluid inlet for the at least one fluid inlet port of the first external battery module for feeding the cooling medium into the battery;
wherein the fluid inlet is fluidically connected to the at least one fluid inlet port of the first external battery module.

22. The battery according to claim 21, further comprising a second end plate, wherein:
the second external battery module includes a housing bottom delimiting the cell volume and arranged on a second side of the cell volume opposite the first side in the first direction;
second end plate is arranged on a side of the housing bottom of the second external battery module facing away from the cell volume in the first direction;
the second end plate includes at least one fluid outlet for discharging the cooling medium from the battery; and
the fluid outlet is fluidically connected to at least one fluid outlet port of the housing bottom of the second external battery module.
